(19) United States
(12) Patent Application Publication
(10) Pub. No.: US 2026/0043891 A1
(43) Pub. Date: Feb. 12, 2026

(54) SENSOR SYSTEM FOR PROVIDING A VEHICLE-ACCESS FUNCTION OF A MOTOR VEHICLE

(71) Applicant: Brose Fahrzeugteile SE & Co. Kommanditgesellschaft, Bamberg, Bamberg (DE)

(72) Inventors: Markus Rosenthal, Bamberg (DE); Philipp Konarski, Hallstadt (DE); Florian Pohl, Ebersdorf (DE)

(21) Appl. No.: 18/995,609

(22) PCT Filed: Jul. 18, 2023
(86) PCT No.: PCT/EP2023/069853

§ 371 Date: Jan. 16, 2025

(30) Foreign Application Priority Data
Jul. 19, 2022 (DE) 10 2022 118 008.5

(51) Int. Cl. G01S 5/02; B60R 25/24

(52) U.S. Cl. CPC G01S 5/0289; G01S 5/0226; B60R 25/245

(57) ABSTRACT

A sensor system for providing a vehicle access functionality of a motor vehicle, which sensor system comprises multiple UWB modules which are arranged with a mutual spacing at predetermined positions on the vehicle, and a control assembly for actuating the UWB modules and for providing the vehicle access functionality by the UWB modules, wherein at least one of the UWB modules is arranged as a moveable UWB module on a hatch of the motor vehicle which is adjustable by means of a hatch kinematic function, such that the moveable UWB module, upon an adjustment of the hatch, is adjustable relative to the remainder of the motor vehicle. The control assembly can be designed to execute a positional determination of the moveable UWB module relative to the remainder of the vehicle, and to provide the vehicle access functionality according to the position of the moveable UWB module thus determined.

### CROSS-REFERENCE TO RELATED APPLICATIONS

This application is a national stage application under 35 U.S.C. 371 of International Patent Application Serial No. PCT/EP2023/069853, entitled “Sensor System for Providing a Vehicle-Access Function of a Motor Vehicle,” filed Jul. 18, 2023, which claims priority from German Patent Application No. DE 10 2022 118 008.5, filed Jul. 19, 2022, the disclosure of which is incorporated herein by reference.

### FIELD OF THE TECHNOLOGY

Various embodiments relate to a sensor system for providing a vehicle access functionality of a motor vehicle.

### SUMMARY

In many cases, vehicle access systems such as passive keyless entry (PKE) and passive entry passive start (PEPS) employ a portable device such as an electronic key for the identification and location of an operator of the motor vehicle. The sensor system in question is based upon the employment of ultra-wideband (UWB) modules which, in particular, enable a particularly accurate location of the operator, wherein the vehicle access functionality can be provided on the basis of this location.

The sensor system comprises multiple UWB modules which, in the installed state, are arranged at predetermined positions on the motor vehicle and, for example, are distributed about the perimeter of the motor vehicle, whereby, inter alia, the reception and transmission range of the sensor system is optimized. As the sensor system in question, in particular, involves an interaction of the operator with a hatch of the motor vehicle, UWB modules can be arranged, individually or in totality, on adjustable hatches. In the present case, the term “hatch” of a motor vehicle is to be understood in a broad sense. This term not only includes tailgates and trunk lids, but also doors, in particular side doors, and side mirrors. In the present sense, a hatch can be mounted in a pivotable or displaceable manner on the bodywork of a motor vehicle.

Various embodiments address the fundamental issue of the configuration and further development of the sensor system in question, such that the operation of the sensor system and, in the particular, the accuracy of location by means of the sensor system, are further improved.

The above-mentioned issue is resolved by various features described herein.

According to various embodiments, at least one of the UWB modules, in the installed state, is arranged as a moveable UWB module on an adjustable hatch of the motor vehicle such that, by an adjustment of the hatch, the position of the moveable UWB module is also variable. Essential to this arrangement is the fundamental consideration that an alteration of the position of the moveable UWB module associated with an adjustment of the hatch is considered in the provision of the vehicle access functionality, wherein the position, in particular, can also be ascertained by the sensor system.

Specifically, it is proposed that the control assembly is designed to execute a positional determination of the moveable UWB module relative to the remainder of the motor vehicle, and to provide the vehicle access functionality according to the position of the moveable UWB module thus determined.

Various embodiments provide a sensor system for providing a vehicle access functionality of a motor vehicle, which sensor system comprises multiple UWB modules which are designed for transmitting and receiving UWB signals and which, in the installed state, are arranged with a mutual spacing at predetermined positions on the motor vehicle, and a control assembly for actuating the UWB modules and for providing the vehicle access functionality by means of the UWB modules, wherein at least one of the UWB modules, in the installed state, is arranged as a moveable UWB module on a hatch of the motor vehicle which is adjustable by means of a hatch kinematic function, such that the moveable UWB module, upon an adjustment of the hatch, is adjustable relative to the remainder of the motor vehicle, wherein the control assembly is designed to execute a positional determination of the moveable UWB module relative to the remainder of the motor vehicle, and to provide the vehicle access functionality according to the position of the moveable UWB module thus determined.

In various embodiments, the control assembly is designed to execute a positional determination of the moveable UWB module by reference to an exchange of UWB signals by the moveable UWB module with at least one further UWB module. In some embodiments, the control assembly, by reference to the exchange of UWB signals, executes a clearance determination and/or an angle determination between the moveable UWB module and the at least one further UWB module.

In various embodiments, the sensor system comprises at least one hatch sensor, which is allocated in the installed state of the hatch and which is designed for capturing the adjustment of the hatch, and in that the control assembly is designed to trigger and/or to execute the positional determination of the moveable UWB module by reference to the capture of adjustment by the hatch sensor. In some embodiments, the hatch sensor is configured as a locking state sensor of a motor vehicle lock which is assigned to the hatch, as a motion sensor, in particular a gyro sensor, and/or as a position sensor.

In various embodiments, the control assembly incorporates a hatch kinematics model for the hatch kinematic function, and that the control assembly is designed to execute a positional determination of the moveable UWB module by reference to the hatch kinematics model.

In various embodiments, vehicle access functionality delivered by the control assembly incorporates a location of an operator, in particular by reference to a portable device which is carried by the operator, and/or in that the control assembly deactivates the moveable UWB module according to the position thus ascertained, executes location in consideration of the position thus ascertained and/or operates the moveable UWB module as a UWB tag, in the event of an open hatch position of the hatch.

### BRIEF DESCRIPTION OF THE DRAWINGS

Various aspects are described in greater detail hereinafter with reference to a drawing which represents a single exemplary embodiment. In the drawing

FIG. 1 shows a motor vehicle having a proposed sensor system, in a schematic overhead view.

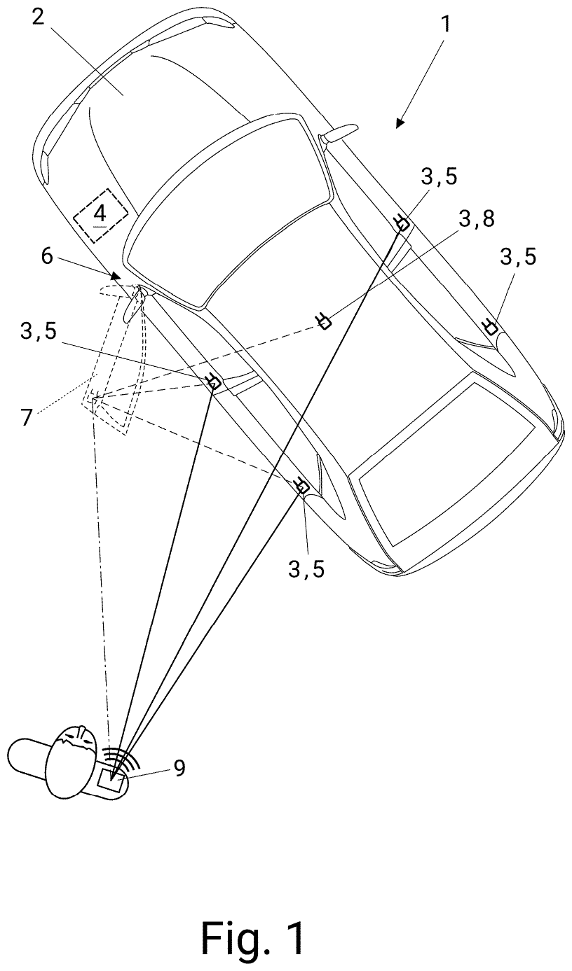

### DETAILED DESCRIPTION

Various embodiments relate to the provision of a vehicle access functionality by means of a sensor system 1, which is based upon UWB technology and which, in particular, is employed for locating an operator externally and/or internally to the motor vehicle 2.

The exemplary embodiment represented in the figure relates to a sensor system 1 for providing a vehicle access functionality of a motor vehicle 2, which sensor system 1 comprises multiple UWB modules 3 which are designed for transmitting and receiving UWB signals and which, in the installed state, are arranged with a mutual spacing at predetermined positions on the motor vehicle 2, and a control assembly 4 for actuating the UWB modules 3 and for providing the vehicle access functionality by means of the UWB modules 3, wherein at least one of the UWB modules 3, in the installed state, is arranged as a moveable UWB module 5 on a hatch 7 of the motor vehicle 2 which is adjustable by means of hatch kinematic function 6, such that the moveable UWB module 5, upon an adjustment of the hatch 7, is adjustable relative to the remainder of the motor vehicle 2.

The vehicle access functionality is generally associated with the access of an operator to the motor vehicle 2, in particular with respect to the unlocking, opening or closing of the hatch 7, the wake-up of vehicle electronics, the start-up of the vehicle drive, or similar. The vehicle access functionality is also associated with a security function, such as a locking operation executed by the operator upon departure from the motor vehicle 2.

The UWB modules 3 are designed for operation using UWB technology and, in particular, are designed for communication in a frequency range of 3.1 GHz to 10.6 GHz. UWB signals can be pulses having a bandwidth of at least 500 MHz, and, in some embodiments, having a duration of an order of magnitude of nanoseconds. A configuration of UWB modules 3 can include an antenna assembly which is designed for UWB operation and a sensor controller for actuating the antenna assembly, which is configured, for example, as a microcontroller.

The UWB modules 3 are configured for a spaced arrangement on the motor vehicle 2, as a result of which the sensor system 1, in service, can access a plurality of spatially distributed UWB modules 3. By means of the spaced arrangement, an extended capture and transmission range of the sensor system 1 can be covered. Moreover, the spaced arrangement of UWB modules 3 can be employed in a location function, for example in the context of a triangulation, or in consideration of a redundancy of UWB modules 3. Arrangement in predetermined positions signifies that at least an element of a degree of freedom in the relative arrangement of UWB modules 3 with respect to one another is predefined. Predetermined positions can be saved and employed in a location function, in particular in a triangulation, or similar.

The control assembly 4 is employed for actuating the UWB modules 3, and executes a delivery of the vehicle access functionality. In the drawing, the control assembly 4 is exemplarily represented as a central control module, which is in communication with the UWB modules 3. Likewise, at least a proportion of control functions can be executed, in a decentralized manner, by the provided sensor controllers, or can also be implemented by a door control device or a motor vehicle controller. The term “control assembly” is thus also to be understood as the entirety of components which, in combination, are employed for actuating the UWB modules 3. The actuation of UWB modules 3 can be employed, as addressed above, for communication in the context of the authentication and location of the operator. The UWB modules 3 can also be designed for radar operation.

At least one of the UWB modules 3 is designed for arrangement on a hatch 7, which module is designated herein as a “moveable” UWB module 5. For the clarification of the term “hatch”, reference may be made to the introductory explanations. In the drawing, side doors, hatchback doors and a tailgate 7 are represented as hatches of the motor vehicle 2, wherein the following explanations exemplarily relate to a side door. The hatch 7 is adjustable by means of a hatch kinematic function 6, which adjustment, in the present case, is executed between a closed hatch position and an open hatch position, and is moreover arranged on the motor vehicle 2.

The term “hatch kinematic function” encompasses all components which enable the movement of the hatch 7. Adjustment of the hatch 7 can be executed with a single degree of freedom (for example, an angular setting about a pivoting axis) or with multiple degrees of freedom (for example, in a combined translational and pivoting motion of a sliding door).

By the arrangement of the moveable UWB module 5, the execution of an adjustment of the hatch 7 is also associated with an adjustment of the moveable UWB module 5, moreover, relative to the motor vehicle 2 and, in particular, relative to the further UWB modules 3 of the sensor system 1. The relative position of the moveable UWB module 5 vis-à-vis the further UWB modules 3 is variable accordingly. In principle, multiple moveable UWB modules 5 can also be provided. Likewise, static UWB modules 8 can be provided which, moreover, are configured in a stationary arrangement relative to the motor vehicle 2, for example on the bodywork. The sensor system 1 can include at least one moveable UWB module 5 and at least one static UWB module 8.

It is essential that the control assembly 4 is designed to execute a positional determination of the moveable UWB module 5 relative to the remainder of the motor vehicle 2, and that the vehicle access functionality is delivered according to the position of the moveable UWB module 5 thus ascertained.

The circumstance whereby the relative position of the moveable UWB module 5 vis-à-vis the further UWB modules 3 is variable is thus considered in the delivery of the vehicle access functionality, for example in a location function. In particular, delivery of the vehicle access functionality can thus be executed in a reliable manner, independently of the respective hatch setting.

According to one configuration, it is provided that the control assembly 4 is designed to execute a positional determination of the moveable UWB module 5 by reference to an exchange of UWB signals by the moveable UWB module 5 with at least one further UWB module 3. In some embodiments, the control assembly 4, by reference to the exchange of UWB signals, executes a clearance determination and/or an angle determination between the moveable UWB module 5 and the at least one further UWB module 3.

Consequently, a positional determination based upon UWB technology is employed, in order to infer the position of the moveable UWB module 5. In various embodiments, the at least one further UWB module 3 comprises at least one static UWB module 8, such that positional determination can be executed with a fixed reference point. However, an exchange of UWB signals between multiple moveable UWB modules 5 for positional determination is also conceivable.

A clearance determination can be executed on the basis of a time-of-flight (ToF) measurement of UWB signals, in particular by reference to a time difference of arrival method and/or a two-way ranging method. An angle determination is executed, for example, by reference to an angle of arrival method and/or a phase difference of arrival method. For an angle determination, at least one of the UWB modules 3 can include an antenna assembly having a plurality of mutually spaced antennae, which enable an angular resolution of UWB signals. An angle determination can also be executed by means of multiple further UWB modules 3.

According to a further configuration, it is provided that the sensor system 1 comprises at least one hatch sensor, which is allocated in the installed state of the hatch 7 and which is designed for capturing the adjustment of the hatch 7, and that the control assembly 4 is designed to trigger and/or to execute the positional determination of the moveable UWB module 5 by reference to the capture of adjustment by the hatch sensor. In some embodiments, the hatch sensor is configured as a locking state sensor of a motor vehicle lock which is assigned to the hatch 7, as a motion sensor, in particular a gyro sensor, and/or as a position sensor.

For example, by reference to the locking state sensor, it can be detected that the hatch 7 is not in the fully closed position, such that a positional determination of the moveable UWB module 5 which is assigned to the hatch 7 can be required accordingly. By means of a motion sensor, such as an acceleration sensor, in particular a gyro sensor, an adjustment of the hatch 7 can also be captured and a positional determination triggered. A position sensor can be assigned, for example, to the hatch kinematic function 6 and can determine, for example, a hatch function, either directly or indirectly.

According to various embodiments, it is provided that the control assembly 4 incorporates a hatch kinematics model for the hatch kinematic function 6, and that the control assembly 4 is designed to execute a positional determination of the moveable UWB module 5 by reference to the hatch kinematics model.

In particular, the hatch kinematics model comprises a digital description of the position of the moveable UWB module 5, according to the hatch setting. In particular, in the case of a hatch kinematic function 6 having only a single degree of freedom, a simple distance measurement between the moveable UWB module 5 and at least one further UWB module 3 can be sufficient for the execution of positional determination. Correspondingly, UWB modules 3 having only a single antenna can also be employed. In this case, for example, the hatch kinematics model defines the track on which the moveable UWB module 5 can move in association with an adjustment of the hatch 7, whereby a clearance determination, at least for a proportion of this track, enables a three-dimensional positional determination of the moveable UWB module 5.

Positional determination can also be executed by means of the hatch sensor only, and by reference to the hatch kinematics model. For example, at least one degree of freedom (for example an angular setting) is captured by means of the hatch sensor, and the position of the moveable UWB module 5 is ascertained herefrom, by reference to the hatch kinematics model.

Moreover, the hatch kinematics model can be employed both in conjunction with an exchange of UWB signals by the moveable UWB module 5 with at least one further UWB module 3, and with the employment of a hatch sensor. For example, positional determination can be executed using a hatch kinematic function 6 having multiple degrees of freedom and/or positions ascertained on the basis of different measuring methods can be mutually compared and validated accordingly.

Positional determination can also be employed for the validation of a sensor signal of the hatch sensor. In the event that, for example, by reference to the hatch sensor, a hatch setting, in particular an open and/or closed position of the hatch 7 is captured, the hatch setting can be checked by means of the control assembly 4, by reference to a distance measurement to the moveable UWB module 5, using UWB signals.

In the present case, as addressed above, it can be provided that the vehicle access functionality delivered by the control assembly 4 incorporates a location of an operator, in particular by reference to a portable device 9 which is carried by the operator.

The portable device 9 can be configured, for example, as an electronic key, a mobile telephone, a PDA, a wearable device, or similar. The portable device 9 is designed for UWB communication with the UWB modules 3 wherein, in addition to the location function, an authentication can also be executed by means of UWB communication. Alternatively, authentication by means of the sensor system 1 can be executed using a further communication mode, which differs from UWB communication. The sensor system 1 can include at least one unrepresented Bluetooth module, which is employed for authentication by means of Bluetooth communication, such as by means of BLE communication.

In principle, the control assembly 4 can deactivate the moveable UWB module 5, according to the position thus ascertained wherein, for example, location is executed by the remaining UWB modules 3. Any defective location associated with a variation in the position of the moveable UWB module 5 is excluded accordingly.

Moreover, the control assembly 4 can execute location in consideration of the position thus ascertained. If location is based, for example, upon a triangulation, the position thus ascertained can be employed as a reference position for the moveable UWB module 5.

In a further configuration, in the event of an open hatch position of the hatch 7, the control assembly 4 operates the moveable UWB module 5 as a UWB tag which, for example, can be employed in an obstacle detection function for further vehicles. Correspondingly, further vehicles, by means of a UWB communication, can be alerted to the effect that, for example, a hatch 7 of the motor vehicle 2 is open, and thus represents a potential obstacle.

A method is further disclosed for operating the proposed sensor system 1. It is essential hereto that, by means of the control assembly 4, a positional determination of the moveable UWB module 5 relative to the remainder of the motor vehicle 2 is executed 2, and that the vehicle access functionality is delivered according to the position of the moveable UWB module 5 thus ascertained. Full reference may be made to the explanations of the sensor system 1.

Moreover, a motor vehicle 2 having a proposed sensor system 1 is disclosed.

1. A sensor system for providing a vehicle access functionality of a motor vehicle, which sensor system comprises multiple UWB modules which are designed for transmitting and receiving UWB signals and which, in the installed state, are arranged with a mutual spacing at predetermined positions on the motor vehicle, and a control assembly for actuating the UWB modules and for providing the vehicle access functionality by the UWB modules, wherein at least one of the UWB modules, in the installed state, is arranged as a moveable UWB module on a hatch of the motor vehicle which is adjustable by means of a hatch kinematic function, such that the moveable UWB module, upon an adjustment of the hatch, is adjustable relative to the remainder of the motor vehicle,
wherein the control assembly is designed to execute a positional determination of the moveable UWB module relative to the remainder of the motor vehicle , and to provide the vehicle access functionality according to the position of the moveable UWB module thus determined.

2. The sensor system as claimed in claim 1, wherein the control assembly is designed to execute a positional determination of the moveable UWB module by reference to an exchange of UWB signals by the moveable UWB module with at least one further UWB module.

3. The sensor system as claimed in claim 1, wherein the sensor system comprises at least one hatch sensor, which is allocated in the installed state of the hatch and which is designed for capturing the adjustment of the hatch, and wherein the control assembly is designed to trigger and/or to execute the positional determination of the moveable UWB module by reference to the capture of adjustment by the hatch sensor.

4. The sensor system as claimed in claim 1, wherein the control assembly incorporates a hatch kinematics model for the hatch kinematic function, and that the control assembly is designed to execute a positional determination of the moveable UWB module by reference to the hatch kinematics model.

5. The sensor system as claimed in claim 1, wherein vehicle access functionality delivered by the control assembly incorporates a location of an operator and/or wherein the control assembly deactivates the moveable UWB module according to the position thus ascertained, executes location in consideration of the position thus ascertained and/or operates the moveable UWB module as a UWB tag, in the event of an open hatch position of the hatch.

6. The sensor system as claimed in claim 2, wherein the control assembly, by reference to the exchange of UWB signals, executes a clearance determination and/or an angle determination between the moveable UWB module and the at least one further UWB module.

7. The sensor system as claimed in claim 3, wherein the hatch sensor is configured as a locking state sensor of a motor vehicle lock which is assigned to the hatch, as a motion sensor and/or as a position sensor.

8. The sensor system as claimed in claim 1, wherein vehicle access functionality delivered by the control assembly incorporates a location of an operator by reference to a portable device which is carried by the operator, and/or wherein the control assembly deactivates the moveable UWB module according to the position thus ascertained, executes location in consideration of the position thus ascertained and/or operates the moveable UWB module as a UWB tag, in the event of an open hatch position of the hatch.
